(19) United States
(12) Patent Application Publication
(10) Pub. No.: US 2018/0029335 A1
(43) Pub. Date: Feb. 1, 2018

(54) RESIN FILM FOR LAMINATED GLASS, LAMINATED GLASS INCLUDING THE SAME, AND VEHICLE INCLUDING THE SAME

(71) Applicants: Hyundai Motor Company, Seoul (KR); SKC Co., Ltd., Suwon-si (KR)

(72) Inventors: Nak Kyoung KONG, Seongnam-si (KR); Ki Hong LEE, Seoul (KR); Sang Young KIM, Hwaseong-si (KR); Soo Nam KIM, Gwacheon-si (KR); Seok Jae PARK, Anyang-si (KR); Tae Soo JUNG, Siheung-si (KR); Young lk CHO, Hwaseong-si (KR); Keon Soo JIN, Ulsan (KR); Keun Sig LIM, Yongin-si (KR); Dong Hwan JANG, Suwon-si (KR); Jong Min PARK, Seoul (KR); Hye Jin KIM, Suwon-si (KR); Kyu Hun KIM, Seoul (KR); Sung Jin CHUNG, Seoul (KR); Je Won YEON, Suwon-si (KR)

(73) Assignees: Hyundai Motor Company, Seoul (KR); SKC Co., Ltd., Suwon-si (KR)

(21) Appl. No.: 15/474,842

(22) Filed: Mar. 30, 2017

(30) Foreign Application Priority Data
Jul. 29, 2016 (KR) 10-2016-0097363

(51) Int. Cl. B32B 17/10; B32B 27/32; B32B 27/06

(52) U.S. Cl. CPC B32B 17/10; B32B 27/06; B32B 27/32; B32B 2250/03

(57) ABSTRACT

The present disclosure relates to a resin film for laminated glass, laminated glass including the resin film, and a vehicle including the laminated glass. The resin film for laminated glass includes a resin layer having a 3-layer structure, and the resin layer is formed of a resin composition of a specific component.

### CROSS-REFERENCE TO RELATED APPLICATION

This application is based on and claims the benefit of priority to Korean Patent Application No. 10-2016-0097363, filed on Jul. 29, 2016, in the Korean Intellectual Property Office, the disclosure of which is incorporated herein in its entirety by reference.

### TECHNICAL FIELD

The present disclosure relates to a resin film for laminated glass, laminated glass including the resin film, and a vehicle including the laminated glass.

### BACKGROUND

In general, when laminated glass including a pair of glass panels and a resin film interposed between the glass panels is broken, fragments thereof do not scatter, ensuring excellent safety, and thus, laminated glass is commonly used as window glass of road vehicles such as automobiles or buildings.

Laminated glass is required to have sound insulation performance. The sound insulation performance is indicated as a frequency-dependent transmission loss, and JIS A 4708 specifies transmission loss according to rating of sound insulation by certain values within a frequency range of 500 Hz or more. However, sound insulation performance is considerably lowered due to a coincidence effect in a frequency region near 2000 Hz. Here, the coincidence effect refers to a phenomenon that, when sound waves are incident to a glass panel, transverse waves propagate on a glass surface due to rigidity and inertia of the glass panel and resonance between the transverse waves and the incident sound waves causes transmission of sound.

Related art laminated glass is useful for preventing scattering of fragments, but it cannot avoid degradation of sound insulation performance due to the coincidence effect in the frequency band near 2000 Hz, so in this sense, the related art laminated glass is required to be improved.

Human beings' ears are known to have remarkably high sensitivity in a frequency range from 1000 to 6000 Hz, compared with other frequency ranges, based on an equivalent loudness curve. This means that removing a degradation of sound insulation performance due to the coincidence effect is significant in desired sound insulation properties.

Thus, in order to enhance sound insulation performance of laminated glass, it is required to reduce the coincidence effect by preventing the degradation in a minimum portion of the transmission loss that occurs from the coincidence effect (hereinafter, the transmission loss in the minimum portion will be referred to as a “TL value”).

In order to prevent a degradation of the TL value, various methods such as increasing mass of laminated glass, configuring multi-laminated glass, dividing an area of laminated glass, improving a structure of supporting laminated glass, and the like, have been proposed. These methods, however, do not show a satisfactory effect and are not appropriate in cost in a commercial aspect.

Demand for sound insulation performance has grown, and for example, high sound insulation performance is required for glass at about room temperature in glass window for building. Thus, laminated glass is required to have desirable sound insulation performance even though an ambient temperature changes in a wide temperature range from a low temperature region to a high temperature region.

However, the highest temperature at which the related art laminated glass manufactured using a resin film foamed of a plasticized polyvinylbutyral resin shows sound insulation performance is a room temperature or more, and sound insulation performance thereof in a vicinity of room temperature is poor. Also, there have been attempts at securing desirable sound insulation performance, but the resin film excessively softens to cause a problem such as panel shear or foaming when combined with a glass panel to manufacture laminated glass.

In detail, a polymer film having a glass transition temperature of 15° C. or lower, for example, a polymer film formed as a stacked body of a vinylchloride-ethylene-glycidyl methacrylate copolymer film and a plasticizer polyvinylacetal film has been presented (please refer to Patent document 1 below). However, the polymer film fails to show sound insulation performance of Ts-35 or more in a rating of sound insulation performance according to JIS A 4706 and is limited in a temperature range at which sound insulation performance is shown, failing to exhibiting desirable sound insulation performance in a large temperature range.

Also, there has been proposed an interlayer for laminated glass including a polyvinylacetal resin in which the sum of a degree of acetalization ranging from 60 to 85 mol % and an acetyl group content ranging from 8 to 30 mol % is 75 mol % or more and a plasticizer having a cloud point of 50° C. or less. The interlayer definitely enhances sound insulation performance and temperature dependence; however, since the interlayer is so soft that it easily causes problems such as panel shear, foaming, and the like, when combined with a glass panel to manufacture laminated glass.

In addition, a structure formed by stacking two or more types of resins having various glass transition temperatures to have vibration damping in a wide temperature range has been proposed (please refer to Patent document 2). The. structure is described to have enhanced vibration damping in a wide temperature range. However, whether the structure has properties required for laminated glass such as sound insulation performance or transparency is not evident in the detailed descriptions thereof and the structure does not meet the requirements for safety glass, such as high impact energy absorption, anti-scattering in case of glass breakage.

Also, an interlayer foamed by stacking a film including polyvinylacetal in which the carbon number of an acetal group is 6 to 10 and a plasticizer and a film formed of polyvinylacetal in which the carbon number of an acetal group is 1 to 4 and a plasticizer has been proposed (Patent document 3 below). This interlayer has enhanced sound insulation performance having a slight change in temperature dependence but not enough.

Also, there has been disclosed an interlayer for laminated glass having a 3-layer structure formed by stacking a sound insulation layer including a polyvinylacetal resin in which the carbon number of an acetal group is 4 to 6 and a molar fraction of an average value of an ethylene group content to which the acetyl group is bonded to the entire ethylene group content of a main chain is 8 to 30 mol % and a plasticizer and a skin layer including a polyvinylacetal resin in which the carbon number of an acetal group is 3 to 4 and a molar fraction of an average value of an ethylene group content to which the acetyl group is bonded to the entire ethylene group content of a main chain is 4 mol % or less and a plasticizer (please refer to Patent document 4). However, in the case of the interlayer having the 3-layer structure, a pattern is formed in an interface between the sound insulation layer and the skin layer during an extruding process of forming the interlayer, degrading an appearance and optical characteristics of the interlayer and the laminated glass.

### RELATED ART DOCUMENT

Patent document 1: Japanese Patent Laid-Open Publication No. H02-229742

Patent document 2: Japanese Patent Laid-Open Publication No. S51-106190

Patent document 3: Japanese Patent Laid-Open Publication No. H04-254444

Patent document 4: Korean Patent Laid-Open Publication No. 1993-0021375

### SUMMARY

The present disclosure has been made to solve the above-mentioned problems occurring in the prior art while advantages achieved by the prior art are maintained intact.

An aspect of the present disclosure provides a resin film for laminated glass capable of enhancing sound insulation performance and optical performance of laminated glass.

Another aspect of the present disclosure provides laminated glass including the resin film for laminated glass.

According to an exemplary embodiment of the present disclosure, a resin film for laminated glass includes: a first resin layer; a second resin layer stacked on the first resin layer; and a third resin layer stacked under the first resin layer, wherein one or more of the second resin layer and the third resin layer are formed of a first resin composition, the first resin composition includes a first polyvinylacetal resin, a first plasticizer, a first ethylene-α-olefin copolymer, a content of the first ethylene-α-olefin copolymer is 0.1 to 10 parts by weight with respect to 100 parts by weight of the first resin composition, and a weight-average molecular weight of the first ethylene-α-olefin copolymer is 1,000 to 30,000.

According to another exemplary embodiment of the present disclosure, a laminated glass includes: the resin film for a laminated glass; a first glass panel stacked on the resin film; and a second glass panel stacked under the resin film.

### BRIEF DESCRIPTION OF THE DRAWINGS

The above and other objects, features and advantages of the present disclosure will be more apparent from the following detailed description taken in conjunction with the accompanying drawings.

FIG. 1 is a cross-sectional view of a resin film for laminated glass according to an exemplary embodiment of the present disclosure.

FIG. 2 is a cross-sectional view of laminated glass according to an exemplary embodiment of the present disclosure.

FIG. 3 is a perspective view of a vehicle in which a wind shield formed of laminated glass according to an exemplary embodiment of the present disclosure is installed.

### DETAILED DESCRIPTION

Hereinafter, the present disclosure will be described.

The present disclosure introduces a specific olygomer, i.e., an ethylene-α-olefin copolymer having a weight-average molecular weight within a specific range into a resin film used in manufacturing laminated glass in order to enhance sound insulation performance, optical performance, manufacturing efficiency, and the like, of laminated glass. This will be described in detail with reference to the accompanying drawings.

1. Resin Film For Laminated Glass

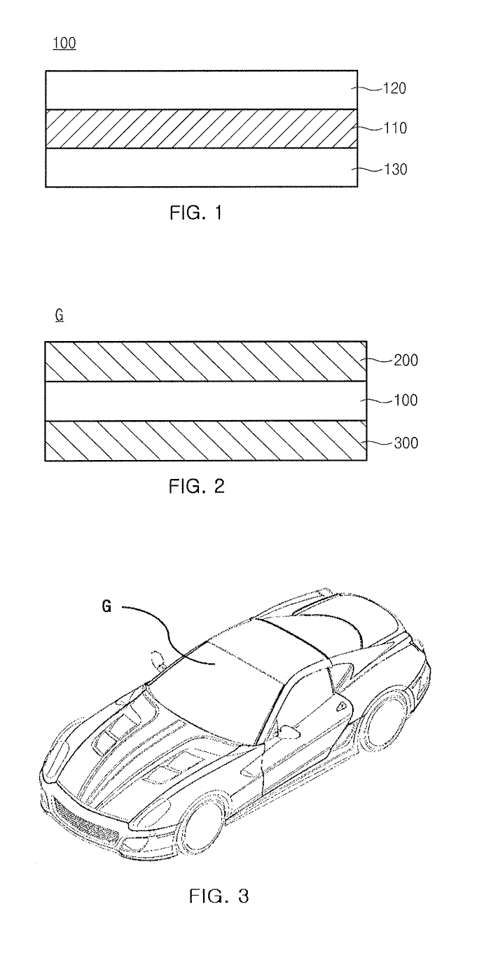

Referring to FIG. 1, a resin film 100 for laminated glass of the present disclosure includes a first resin layer 110, a second resin layer 120, and a third resin layer 130.

The first resin layer 110 included in the resin film 100 for laminated glass of the present disclosure serves as a sound insulation layer blocking ambient noise by damping noise. A resin composition used for forming the first resin layer 110 is not particularly limited and may be formed of a second resin composition including a second polyvinylacetal resin (A) and a second plasticizer.

The second polyvinylacetal resin (A) included in the second resin composition, which is obtained by acetalizing polyvinylalcohol with aldehyde, may have a specific acetyl group content. Also, the second polyvinylacetal resin (A) may have an acetal group, an acetyl group, and a hydroxyl group in an ethylene group of a main chain. In detail, the second polyvinylacetal resin (A) may be obtained as powder by maintaining a polyvinylalcohol aqueous solution obtained by dissolving polyvinylalcohol in a hydrothermal solution at a predetermined temperature, applying aldehyde and a catalyst and performing acetalization to obtain a reaction solution, maintaining the reaction solution at a high temperature, and subsequently performing processes such as neutralization, washing, and drying.

Here, when acetalization is performed on the polyvinylalcohol, the second polyvinylacetal resin (A) having crosslinked molecules may be easily obtained by using aldehyde in an excessive amount of 10 to 200 mol %, relative to a degree of acetalization of the obtained second polyvinylacetal resin (A), or adding a greater amount of catalyst than that of a general case. Here, if the excessive amount of aldehyde is less than 10 mol %, crosslinking may not be easily made between molecules, having a difficulty in obtaining required sound insulation performance within a wide temperature range, and if the excessive amount of aldehyde exceeds 200 mol %, gelation may occur in a process of preparing the second polyvinylacetal resin (A) or a reaction with the aldehyde may be lowered. Thus, preferably, aldehyde is used in an excessive amount of 10 to 200 mol %, relative to the degree of acetalization of the second polyvinylacetal resin (A), and, more preferably, in an excessive amount of 15 to 50 mol %.

In addition, the second polyvinylacetal resin (A) may also be obtained by making a crosslinking reaction between molecules by adding a small amount of multifunctional aldehyde. The multifunctional aldehyde is not particularly limited and may be glutaraldehyde, 4,4′-(ethylenedioxy)dibenzaldehyde, 2-hydroxyhexanediol, and the like, in a non-limiting example. Also, the content of the multifunctional aldehyde is not particularly limited and is preferably 0.001 to 1.0 mol % with respect to mol % of a hydroxyl group of polyvinylalcohol and, more preferably, 0.01 to 0.5 mol %.

In the second polyvinylacetal resin (A), preferably, the carbon number of the acetal group is 4 to 6, the acetyl group content (which refers to a molar fraction of an average value of the ethylene group content to which the acetal group is bonded to the entire ethylene group content of a main chain and which may be measured on the basis of JIS K 6728) is 8 to 30 mol %, and a degree of acetalization is 40 mol % or more.

If the acetyl group content in the second polyvinylacetal resin (A) is less than 8 mol %, sound insulation performance of the resin film may be degraded, and if the acetyl group content in the second polyvinylacetal resin (A) exceeds 30 mol %, reactivity with aldehyde may be lowered. Here, more preferably, the acetyl group content of the second polyvinylacetal resin (A) is 10 to 24 mol %.

Also, if the degree of acetalization of the second polyvinylacetal resin (A) is less than 40 mol %, compatibility with the second plasticizer is degraded and it is difficult to add the second plasticizer by an amount required for exhibiting sound insulation performance. In particular, as the second polyvinylacetal resin (A), preferably, a second polyvinylacetal resin (A) having a narrow distribution of a degree of acetalization, specifically, 90% or more of a distribution of the degree of acetalization is within a range of −2 mol % and +2 mol % of an average value of the degree of acetalization is used. This is because, when the second polyvinylacetal resin (A) having a narrow distribution of the degree of acetalization is used, a resin film exhibiting excellent sound insulation performance within a wide temperature range may be obtained. Specifically, such a resin film may pass a JIS sound insulation rating Ts−40.

The second polyvinylacetal resin (A) having a narrow distribution of a degree of acetalization may be obtained by lowering a temperature, preferably, to 5° C. or lower, when aldehyde and a catalyst are added to a polyvinylalcohol aqueous solution. Also, the second polyvinylacetal resin (A) may be obtained by reducing usage of the catalyst to 60 wt %, relative to general usage. According to circumstances, the second polyvinylacetal resin (A) may also be obtained by gradually applying a small amount of catalyst each time for 30 minutes to 3 hours, or by separately extracting a synthetic polyvinylacetal resin with a narrow distribution of the degree of acetalization in every degree of acetalization of a certain range using various types of solvents having different polarities. The distribution of the degree of acetalization of the second polyvinylacetal resin (A) may be measured through liquid chromatography or thin layer chromatography.

An average degree of polarization of polyvinylalcohol in which a raw material used for preparing the second polyvinylacetal resin (A) is not particularly limited and preferably, from 500 to 5,000, and more preferably, from 1,000 to 2,500. If the average degree of polarization is less than 500, penetration resistance of laminated glass may be degraded, and if the average degree of polarization exceeds 5,000, strength of the laminated glass may be excessively increased to cause restrictions in application fields.

Also, aldehyde used for obtaining the second polyvinylacetal resin (A) in which the carbon number of the acetal group is 4 to 6 is not particularly limited and n-butylaldehyde, isobutylaldehyde, valeraldehyde, n-hexylaldehyde, or 2-ethylbutylaldehyde having the carbon number of 4 to 6 may be used alone or two or more thereof may be mixed to be used. Among them, preferably, n-butylaldehyde, isobutylaldehyde, or n-hexylaldehyde is used alone or two or more thereof is mixed to be used, and more preferably, n-butylaldehyde capable of increasing adhesion strength between layers is used. If the carbon number of aldehyde is less than 4, sound insulation performance may be degraded, and if the carbon number of aldehyde exceeds 6, reactivity of acetalization and sound insulation performance in the vicinity of room temperature may be degraded.

In the second polyvinylacetal resin (A), a standard deviation α of the ethylene group content to which an acetyl group is bonded is preferably 2.5 to 8, and more preferably, 3 to 6. If the standard deviation α is less than 2.5, obtaining good sound insulation performance within a wide temperature range may be limited, and if the standard deviation α exceeds 8, a maximum value of sound insulation performance may be lowered. The standard deviation represents a numerical value indicating how many ethylene groups are bonded to a single acetyl group, which may be measured through C-NMR analysis.

Here, a method for preparing the second polyvinylacetal resin (A) whose standard deviation α is 2.5 to 8 is not particularly limited and, in a non-limiting example, a method of acetalizing polyvinylalcohol obtained by performing saponification on polyacetic acid vinyl at several stages, a method of acetalizing a mixture of a plurality of polyvinylalcohols having different degrees of saponification, a method of mixing a plurality of polyvinylacetal resins having different acetyl group contents, and the like, may be used.

A molecular weight distribution ratio (Mw/Mn) of the second polyvinylacetal resin (A) is preferably 1.01 to 1.50. Since the second polyvinylacetal resin (A) whose molecular weight distribution ratio (Mw/Mn) is 1.01 to 1.50 is used, a coincidence effect in the vicinity of room temperature is significantly alleviated, and excellent sound insulation performance having a sound insulation rating exceeding Ts-35 rating based on JIS A 4706 may be obtained. If the molecular weight distribution ratio (Mw/Mn) is less than 1.01, it may be difficult to synthesize the second polyvinylacetal resin (A), and if the molecular weight distribution ratio (Mw/Mn) exceeds 1.50, a TL value may be lowered. In this manner, the second polyvinylacetal resin (A) having the narrow range of distribution ratio (Mw/Mn) may be obtained by fractionating known polyvinylacetal using fractionation chromatography.

Also, a number average molecular weight (Mn) of the second polyvinylacetal resin (A) is preferably 27,000 to 270,000 and, more preferably, 45,000 to 235,000. If the number average molecular weight is less than 27,000, penetration resistance of laminated glass may be degraded, and if the number average molecular weight exceeds 270,000, strength of the laminated glass may be excessively increased to cause restrictions in application fields.

Also, in the second polyvinylacetal resin (A), a degree of blocking of ethylene groups to which the acetyl group is bonded is preferably 0.55 to 0.90 and, more preferably, 0.65 to 0.80. If the degree of blocking is less than 0.55, sound insulation performance may be degraded, and if it exceeds 0.90, a degree of acetalization may be reduced to degrade impact resistance of the laminated glass.

The second polyvinylacetal resin (A) may be obtained by acetalizing polyvinylalcohol in which a degree of blocking of ethylene groups to which an acetyl group is bonded is 0.55 to 0.90. When the polyvinylalcohol having high randomness is used, the second polyvinylacetal resin (A) having a low glass transition temperature may be obtained, and a resin film having desirable liquidity and capable of effectively converting negative energy into thermal energy may be prepared using the second polyvinylacetal resin (A).

Meanwhile, the second polyvinylacetal resin (A) is preferably a cross-linked polyvinylacetal resin having viscosity of 200 to 1000 cP (measured by a BM-type viscometer) when 10 wt % of the second polyvinylacetal resin is dissolved in a mixture solution (weight ratio: 1:1) of ethanol and toluene, and more preferably, a cross-linked polyvinylacetal resin having viscosity of 300 to 800 cP. When the cross-linked polyvinylacetal resin is used, a temperature range valid in converting negative energy into thermal energy may expand to obtain a resin film having excellent sound insulation performance even in the vicinity of room temperature.

In addition, as the second polyvinylacetal resin (A), a mixture obtained by mixing two or more types of polyvinylacetal resin obtained by acetalizing polyvinylalcohol with aldehyde, or a polyvinylacetal resin obtained by performing acetalization with other aldehyde than the foregoing aldehyde within a range not exceeding 30 wt % with respect to the entire acetal part may also be used.

The content of the second polyvinylacetal resin (A) is not particularly limited and, preferably, 60 to 68 parts by weight with respect to 100 parts by weight of a second resin composition.

The second plasticizer included in the second resin composition is not particularly limited and, an ester-based plasticizer such as monobasic acid ester, polybasic acid ester, and the like, or a phosphoric acid-based plasticizer such as an organic phosphoric acid-based, an organic phosphorous acid-based, and the like, may be used as the second plasticizer in a non-limiting example.

The monobasic acid ester is preferably, a glycol-based ester obtained by reacting triethyleneglycol, tetraethyleneglycol, tripropyleneglycol, and the like, with an organic acid such as a butyric acid, an isobutyric acid, a caproic acid, a 2-ethylbutyric acid, heptanoic acid, an n-octylic acid, a 2-ethylhexyl acid, a pelargonic acid (n-nonylic acid), a decylic acid, and the like. In detail, a non-limiting example of the monobasic acid ester may be triethyleneglycol-di-2-ethylbutylate, triethyleneglycol-di-2-ethylhexoate, triethyleneglycol-dicapronate, triethyleneglycol-di-n-octate, and the like.

The polybasic acid ester is preferably ester obtained by reacting a straight-chain or molecular alcohol having the carbon number of 4 to 8 with an organic acid such as an adipic acid, a cebacic acid, an azelaic acid, and the like. In detail, a non-limiting example of polybasic acid ester may be dibutyl sebacate, dioctylazelate, dibutylcarbitoladipate, and the like.

A non-limiting example of the phosphoric acid-based plasticizer may be tributoxyethylphosphate, isodecylphenylphosphate, triisopropylphosphite, and the like.

In addition, a general plasticizer known in the art may also be used as the second plasticizer.

The content of the second plasticizer is not particularly limited and preferably 30 to 40 parts by weight with respect to 100 parts by weight of the second resin composition.

The second resin composition may selectively further include a second ethylene-α-olefin copolymer, a second silane-based compound, and a second additive.

The second ethylene-α-olefin copolymer is preferably olygomer having a weight-average molecular weight of 1,000 to 30,000, and more preferably, olygomer having a weight-average molecular weight of 3,000 to 5,000.

α-olefin of the second ethylene-α-olefin copolymer is not particularly limited and preferably one or more selected from the group consisting of propylene, 1-butene, 1-pentene, 4-methyl-l-pentene, 1-hexene, 1-heptene, 1-octene, 1-decene, 1-undecene, 1-dodecene, 1-tetradecene, 1-hexadecene, and 1-itocene.

Also, in the second ethylene-α-olefin copolymer, preferably, a content of a repeating unit (a) derived from ethylene is 30 to 90 mol % and a content of a repeating unit (b) derived from α-olefin is 10 to 70 mol %.

The content of the second ethylene-α-olefin copolymer is not particularly limited and may be 0.1 to 10 parts by weight with respect to 100 parts by weight of the second resin composition.

The second silane-based compound serves to enhance compatibility (dispersibility) of the second polyvinylacetal resin (A) and the second ethylene-α-olefin copolymer and adhesion between layers. The second silane-based compound is not particularly limited and may be trimethoxy(octyl)silane, trimethoxy(octadecyl)silane, and the like.

The content of the second silane-based compound is not particularly limited and preferably 0.01 to 3 parts by weight with respect to 100 parts by weight of the second resin composition.

The second additive is added to enhance physical properties of the second resin composition. The second additive is not particularly limited and preferably one or more selected from the group consisting of an ultraviolet absorbent, an ultraviolet stabilizer, an anti-oxidant, and a heat stabilizer.

The ultraviolet absorbent is not particularly limited and may be benzotriazole-based, a benzophenone-based, a cyanoacrylate-based, and the like, in a non-limiting example. The benzotriazole-based ultraviolet absorbent may be 2-(2′-hydroxy-5′-methylphenyl)benzotriazole, 2-(2′-hydroxy-5′-t-butylphenyl) benzotriazole, 2-(2′-hydroxy-3′,5′-di-t-butylphenya) benzotriazole, 2-(2′-hydroxy-3′-t-butyl-5′-methylphenyl)-5-chlorobenzotriazole, 2-(2′-hydroxy-3′,5′-di-t-butylphenyl)-5- chlorobenzotriazole, 2-(2′-hydroxy-3′,5′-di-t-amylphenyl)benzotriazole, 2-[2′-hydroxy-3′-(3″,4″,5″,6″-tetrahydrophthalamidemethyl)-5′-methylphenyl] benzotriazole, and the like. Also, the benzophenone-based ultraviolet absorbent may be 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-methoxybenzophenone, 2,2′-dihydroxy-4,4′-dimethoxybenzophenone, 2-hydroxy-4-methoxy-5-sulfonbenzophenone, and the like. Also, the cyanoacrylate-based ultraviolet absorbent may be 2-ethylhexyl-2-cyano-3,3′-diphenylacrylate, ethyl-2-cyano-3,3′-diphenylacrylate, and the like.

The heat stabilizer is not particularly limited and may be a surfactant such as sodium lauryl sulfate, an alkylbenzene sulfonic acid, and the like.

The ultraviolet stabilizer is not particularly limited and may be a hindered amine-based ultraviolet stabilizer, a metal complex salt-based ultraviolet stabilizer, and the like. The hindered amine-based ultraviolet stabilizer may be bis(2,2,6,6-tetramethyl-4-piperidyl) sebacate, tetrakis(2,2,6,6-tetramethyl-4-piperidyl) 1,2,3,4-butanetetracarboxylate, Sanol LS-770, Sanol LS-765, Sanol LS-2626, Chimassob 944LD, Thinuvin-622 LD, Mark LA-57, Mark LA-77, Mark LA-62, Mark LA-67, Mark LA-63, Mark LA-68, Mark-82, Mark LA-87, Goodrite UV-3404, and the like. Also, the metal complex salt-based ultraviolet stabilizer may be nickel[2,2]-thiobis(4-t-octyl)phenolate]-n-butylamine, nickeldibutyl dithiocarbamate, nickelbis[0-ethyl-3,5-(di-t-butyl-4-hydroxybenzyl)]phosphate, cobaltdicyclohexyldithiophosphate, [1-phenyl-3-methyl-4-decanonyl-pyrazolate] nickel, and the like.

The anti-oxidant is not particularly limited and may be a phenol-based anti-oxidant, a sulfur-based anti-oxidant, a phosphorus-based anti-oxidant, and the like. In detail, the anti-oxidant may be 2,6-di-t-butyl-p-cresol(BHT), butylated hydroxyanisole(BHA), 2,6-di-t-butyl-4-ethylphenol, stearyl-β-(3,5-di-t-butyl-4-hydroxyphenyl)propionate, 2,2′-methylene-bis-(4-methyl-6-butylphenone), 2,2′-methylene-bis-(4-ethyl-6-t-butylphenol), 4,4′-thiobis-(3-methyl-6-t-butylphenol), 4,4′-butylidene-bis-(3-methyl-6-t-butylphenol), 1,1,3-tris-(2-methyl-hydroxy-5-t-butylphenyl)butane, tetrakis[methylene-3-(3′,5′-butyl-4′-hydroxyphenyl)propionate]methane, 1,1,3-tris-(2-methyl-4-hydroxy-5-t-butylphenol)butane, 1,3,5-trimethyl-2,4,6-tris(3,5-di-t-butyl-4-hydroxybenzil)benzene, bis(3,3’-bis-(4′-hydroxy-3′-t-butylphenol)butylic acid)glycolester, and the like.

The content of the second additive is not particularly limited and preferably 0.01 to 5 parts by weight with respect to 100 parts by weight of the second resin composition.

The resin film 100 for laminated glass of the present disclosure includes a second resin layer 120 stacked on the first resin layer 110 and a third resin layer 130 stacked under the first resin layer 110. One or more of the second resin layer 120 and the third resin layer 130 may be formed of a first resin composition and, preferably, both the second resin layer 120 and the third resin layer 130 are formed of the first resin composition.

The first resin composition includes a first polyvinylacetal resin (B), a first plasticizer, and a first ethylene-α-olefin copolymer.

The first polyvinylacetal resin (B) included in the first resin composition, which is obtained by acetalizing polyvinylalcohol with aldehyde, may have a specific acetyl group content. Also, the first polyvinylacetal resin (B) may have an acetal group, an acetyl group, and a hydroxyl group in an ethylene group of a main chain. In detail, the first polyvinylacetal resin (B) may be obtained as powder by maintaining a polyvinylalcohol aqueous solution obtained by dissolving polyvinylalcohol in a hydrothermal solution at a predetermined temperature, applying aldehyde and a catalyst and performing acetalization to obtain a reaction solution, maintaining the reaction solution at a high temperature, and subsequently performing processes such as neutralization, washing, and drying.

In the first polyvinylacetal resin (B), preferably, the carbon number of the acetal group is 3 to 4, the acetyl group content (which refers to a molar fraction of an average value of the ethylene group content to which the acetyl group is bonded to an entire ethylene group content of a main chain and which may be measured on the basis of JIS K 6728) is 4 mol % or less, and a degree of acetalization is 50 mol % or more.

If the acetyl group content in the first polyvinylacetal resin (B) exceeds 4 mol %, a difference between the acetyl group content and an average value of the acetyl group content of the second polyvinylacetal resin (A) is small and sound insulation performance of the resin film may be degraded. Here, more preferably, the acetyl group content of the first polyvinylacetal resin (B) is 0.1 to 2 mol %.

An average degree of polymerization of polyvinylalcohol, a raw material used for preparing the first polyvinylacetal resin (B) is not particularly limited and preferably 500 to 5,000 and, more preferably, 1,000 to 2,500. If the average degree of polymerization is less than 500, penetration resistance of the laminated glass may be degraded, and if the average degree of polymerization exceeds 5,000, strength of the laminated glass may be excessively increased to cause restrictions in application fields.

Also, aldehyde used for obtaining the first polyvinylacetal resin (B) in which the carbon number of the acetal group is 3 to 4 is not particularly limited and propion aldehyde, n-butylaldehyde, or isobutylaldehyde having the carbon number of 3 to 4 may be used alone or two or more thereof may be mixed to be used. Among them, preferably, n-butylaldehyde capable of increasing bonding strength between layers is used.

A number average molecular weight (Mn) of the first polyvinylacetal resin (B) is preferably 27,000 to 270,000 and, more preferably, 45,000 to 235,000. If the number average molecular weight is less than 27,000, penetration resistance of laminated glass may be degraded, and if the number average molecular weight exceeds 270,000, strength of the laminated glass may be excessively increased to cause restrictions in application fields.

Also, in the first polyvinylacetal resin (B), a degree of blocking of ethylene groups to which the acetyl group is bonded is preferably 0.15 to 0.40 and, more preferably, 0.20 to 0.35. If the degree of blocking is less than 0.15, sound insulation perfomance may be degraded, and if it exceeds 0.40, a degree of acetalization may be reduced to degrade impact resistance of the laminated glass. The first polyvinylacetal resin (B) may be obtained by acetalizing polyvinylalcohol in which a degree of blocking of ethylene groups to which an acetyl group is bonded is 0.15 to 0.40. When the polyvinylalcohol having high randomness is used, the first polyvinylacetal resin (B) having a low glass transition temperature may be obtained, and a resin film having desirable liquidity and capable of effectively converting negative energy into thermal energy may be prepared using the first polyvinylacetal resin (B).

In addition, as the first polyvinylacetal resin (B), a mixture obtained by mixing two or more types of polyvinylacetal resin obtained by acetalizing polyvinylalcohol with aldehyde, or a polyvinylacetal resin obtained by performing acetalization with other aldehyde than the foregoing aldehyde within a range not exceeding 30 wt % with respect to the entire acetal part.

The content of the first polyvinylacetal resin (B) is not particularly limited and, preferably, 65 to 75 parts by weight with respect to 100 parts by weight of the first resin composition.

The first plasticizer included in the first resin composition is not particularly limited and, an ester-based plasticizer such as monobasic acid ester, polybasic acid ester, and the like, or a phosphoric acid-based plasticizer such as an organic phosphoric acid-based plasticizer, an organic phosphorous acid-based plasticizer, and the like, may be used as the second plasticizer in a non-limiting example. Here, descriptions of the ester-based plasticizer and the phosphoric acid-based plasticizer are the same as the descriptions of the second plasticizer, so the redundant descriptions will be omitted.

The content of the first plasticizer is not particularly limited and preferably 20 to 30 parts by weight with respect to 100 parts by weight of the first resin composition.

The first ethylene-α-olefin copolymer included in the first resin composition is olygomer having a weight-average molecular weight of 1,000 to 30,000 (specifically, 3,000 to 5,000).

Here, α-olefin of the first ethylene-α-olefin copolymer is not particularly limited and preferably one or more selected from the group consisting of propylene, 1-butene, 1-pentene, 4-methyl-l-pentene, 1-hexene, 1-heptene, 1-octene, 1-decene, 1-undecene, 1-dodecene, 1-tetradecene, 1-hexadecene, and 1-itocene.

Also, in the first ethylene-α-olefin copolymer, preferably, a content of a repeating unit (a) derived from ethylene is 30 to 90 mol %, and a content of a repeating unit (b) derived from α-olefin is 10 to 70 mol %.

The content of the first ethylene-α-olefin copolymer is not particularly limited and preferably 0.1 to 10 parts by weight with respect to 100 parts by weight of the first resin composition.

The first resin composition may further selectively include a first silane-based compound and a first additive.

The first silane-based compound serves to enhance compatibility (dispersibility) of the first polyvinylacetal resin and the first ethylene-α-olefin copolymer and adhesion between the layers. The first silane-based compound is not particularly limited and may be trimethoxy(octyl)silane or trimethoxy(octadecyl)silane.

Also, the content of the first silane-based compound is not particularly limited and preferably 0.01 to 5 parts by weight with respect to 100 parts by weight of the first resin composition.

The first additive is added to enhance physical properties of the first resin composition. The first additive is not particularly limited and preferably one or more selected from the group consisting of an ultraviolet absorbent, an ultraviolet stabilizer, an anti-oxidant, and a heat stabilizer. Here, descriptions of the ultraviolet absorbent, the ultraviolet stabilizer, the anti-oxidant, and the heat stabilizer are the same as the descriptions of the second additive, so the redundant descriptions will be omitted. However, since the second resin layer 120 and the third resin layer 130 are required to have ultraviolet blocking performance, compared with the first resin layer 110, preferably, an ultraviolet absorbent having an effective ultraviolet absorption wavelength of 300 to 340 nm is added to obtain an ultraviolet absorption coefficient X of 0.01 or more. The ultraviolet absorption coefficient X is a value defined by {pressure t(mm) of film of second resin layer 120 or third resin layer 130}×{ ultraviolet absorbent content u (parts by weight)}.

The content of the first additive is not particularly limited and preferably 0.01 to 5 parts by weight with respect to 100 parts by weight of the first resin composition.

Meanwhile, the second resin layer 120 and the third resin layer 130 may have an appropriate maximum coefficient of static friction.

In detail, the second resin layer 120 may have a maximum coefficient of static friction ranging from 0.90 to 1.41 at about 20° C., a maximum coefficient of static friction ranging from 1.25 to 1.70 at about 40° C., and a maximum coefficient of static friction ranging from 1.40 to 2.10 at about 45° C.

Also, the third resin layer 130 may have a maximum coefficient of static friction ranging from 0.90 to 1.41 at about 20° C., a maximum coefficient of static friction ranging from 1.25 to 1.70 at about 40° C., and a maximum coefficient of static friction ranging from 1.40 to 2.10 at about 45° C.

Since the second resin layer 120 and the third resin layer 130 serving as skin layers have the maximum coefficient of static friction within the aforementioned ranges, an advantageous effect may be obtained when laminated glass is manufactured using the resin film 100 for laminated glass of the present disclosure.

In detail, the laminated glass is manufactured through operations such as cutting, grinding, forming, cleansing, bonding, and the like. Here, bonding is an operation of inserting a resin film (PVB film) between two sheets of glass and removing internal air to enhance bonding strength of the glass and the resin film, and securing visibility as bonding glass. In order to control physical properties of laminated glass during the bonding process, a temperature (15 to 45° C.) and humidity (15 to 40% RH) are managed.

Here, however, when the laminate having a structure in which the resin film is inserted between the two sheets of glass is transferred to perform the bonding process, a slip phenomenon may occur between interfaces of the glass and the resin film, and in this case, the two sheets of glass and the resin film may be bonded in a misaligned state to manufacture laminated glass with defective pairing.

However, since the resin film 100 for laminated glass of the present disclosure includes the second resin layer 120 and the third resin layer 130 having the maximum coefficient of static friction of the foregoing specific range, defective pairing may be prevented during the process of manufacturing laminated glass.

In the resin film 100 for laminated glass of the present disclosure, since the resin composition used for forming the first resin layer 110, the second resin layer 120, or the third resin layer 130 includes the ethylene-α-olefin copolymer having a weight-average molecular weight of 1,000 to 30,000, a glass transition temperature range of each resin layer widens to reduce stress due to negative energy, enhancing sound insulation performance of the resin film 100 for laminated glass.

Also, since the glass transition temperature range of each resin layer widens, when the resin film 100 for laminated glass is prepared by extruding the resin layers, shearing stress between the resin layers may be increased to minimize pattern formation, and thus, preparation efficiency of the resin film 100 for laminated glass may be enhanced by 1.5 times or more, compared with the related art.

2. Laminated Glass

The present disclosure provides laminated glass including a resin film, a first glass panel, and a second glass panel.

In detail, referring to FIG. 2, the resin film 100 included in a laminated glass G is positioned in the middle of the laminated glass G and is the same as described above, so descriptions thereof will be omitted.

A first glass panel 200 and a second glass panel 300 included in the laminated glass G of the present disclosure are stacked on and under the resin film 100, respectively. The first glass panel 200 and the second glass panel 300 are not particularly limited and may be any glass panel known in the art. The first glass panel 200 and the second glass panel 300 may include the same component or different components. In detail, as the first glass panel 200 and the second glass panel 300, float plate glass, polished plate glass, figured glass, wired sheet glass, lined glass, colored glass, heat absorbing glass, and the like, may be used. Also, in addition to inorganic glass, polycarbonate, polymethylmethacrylate, and the like, having excellent transparency may be used.

The laminated glass G of the present disclosure may be manufactured according to a method known in the art. In a non-limiting example, the laminated glass G of the present disclosure may be manufactured by inserting the resin film 100 between the first glass panel 200 and the second glass panel 300, heating or melting, and subsequently cooling or solidifying the same.

Since the laminated glass G of the present disclosure includes the resin film 100 described above, the laminated glass G of the present disclosure has excellent sound insulation performance and optical performance.

3. Vehicle

The present disclosure provides a vehicle including a wind shield formed of laminated glass.

In detail, referring to FIG. 3, the vehicle of the present disclosure includes a wind shield formed of the laminated glass G as a front glass. The wind shield serves to allow a driver to observe the outside with his or her naked eyes and block wind from the outside. Since the wind shield is formed of the laminated glass G, the wind shield has excellent sound insulation performance, optical performance, and ultraviolet blocking performance.

Hereinafter, exemplary embodiments of the present disclosure will be described in detail. However, the exemplary embodiments described hereinafter are merely illustrative and the present disclosure is not limited thereto.

### EXAMPLE

Degrees of acetalization of first and second polyvinylacetal resins (B) and (A) were measured by preparing heavy water-benzene solution of 2 wt % of a resin, adding a small amount of tetramethylsilane [(CH₃)₄Si] as a standard material, and taking a proton nuclear magnetic resonance spectrum of the first and second polyvinylacetal resins (B) and (A) at a temperature of 23° C.

Average values of acetal group contents of the first and second polyvinylacetal resins (B) and (A) were measured on the basis of “Test method of vinylacetal” of paragraphs of composition analysis in JIS [polyvinylacetal test method] (K-6728-1977).

Fractionation of the first and second polyvinylacetal resins (B) and (A), GPC (LS-8000 system) was used as Fractionation chromatography, HFIP Fractionation column of Showa Denko was used as a column, and hexafluoroisopropanol was used as a solvent.

### Example 1

1) Preparation of First Polyvinylacetal Resin (B)

190 g of polyvinylalcohol having polarization of 1,700 was applied to 2,910 g of pure water and dissolved, while increasing a temperature. A reaction system was adjusted to 12° C., and 201 g of hydrochloric acid having a 35 wt % and 124 g of butylaldehyde were applied to precipitate polyvinylacetal. Thereafter, the reaction system was maintained at a temperature of 50° C. for four hours and the reaction was completed. The resultant material was washed with an excessive amount of water to wash out non-reacted aldehyde. Thereafter, the resultant material was neutralized with a hydrochloric acid catalyst to remove salt, and dried to obtain a first polyvinylacetal resin (B) of white powder. A degree of acetalization of the obtained first polyvinylacetal resin (B) was 65.9 mol % and an acetyl group content was 0.9 mol %.

2) Preparation of Second Polyvinylacetal Resin (A)

191 g of polyvinylalcohol having polarization of 1,700 was applied to 2,890 g of pure water and dissolved, while increasing a temperature. A reaction system was adjusted to 12° C., and 201 g of hydrochloric acid having a 35 wt % and 130 g of butylaldehyde were applied to precipitate polyvinylacetal. Thereafter, the reaction system was maintained at a temperature of 50° C. for five hours and the reaction was completed. The resultant material was washed with an excessive amount of water to wash out non-reacted aldehyde. Thereafter, the resultant material was neutralized with a hydrochloric acid catalyst to remove salt, and dried to obtain a second polyvinylacetal resin (A) of white powder. A degree of acetalization of the obtained second polyvinylacetal resin (A) was 60.2 mol % and an acetyl group content was 11.9 mol %.

3) Preparation of First Resin Composition for Forming Second Resin Layer and Third Resin Layer

70.9 g of the first polyvinylacetal resin (B) was collected, and 26 g of triethyleneglycol-di-2-ethylbutyrate as a first plasticizer, 0.6 g of 2-(2′-hydroxy-5-methylphenyl)benzotriazole as a ultraviolet absorbent, 2 g of EXCEREX™ of MITSUI as a first ethylene-α-olefin copolymer, and 0.5 g of trimethoxy(octyl)silane as a first silane-based compound were added and mixed and sufficiently roll-mixing-milled with a mixing roller to prepare a first resin composition.

4) Preparation of Second Resin Composition for Forming First Resin Layer

63.85 g of the second polyvinylacetal resin (A) was collected, 36 g of triethylglycol-di-2-ethylbutyate as a second plasticizer and 0.15 g of tetrakis[methylene-3-(3′,5′-butyl-4′-hydroxyphenyl)propionate]methane as an anti-oxidant were added and mixed and sufficiently roll-mixing-milled with a mixing roller to prepare a second resin composition.

5) Preparation of Resin Film

The first resin composition and the second resin composition were simultaneously extruded and underwent a casting process to prepare a resin film in which a second resin layer/a first resin layer/a third resin layer were sequentially stacked. As extruding equipment, TEX, 70 Φ extruder, Brabender J was used and a screw speed was 300 rpm. In the prepared resin film, a thickness of the second resin layer was 0.2 mm, a thickness of the first resin layer was 0.2 mm, and a thickness of the third resin layer was 0.2 mm.

Thereafter, surface roughness of the second resin layer and the third resin layer is adjusted to 32 μm using a melt fracture method.

6) Manufacturing Laminated Glass

The resin film was sandwiched with two sheets of float plate glass having each one side of 30 cm, having a square shape, and a thickness of 3 mm, put into a rubber bag, deaerated at a degree of vacuum of 20 torr for 20 minutes, moved to an oven of 90° C., and the temperature was maintained for 30 minutes. Thereafter, a resultant structure was temporarily adhered using a vacuum press and subsequently thermally compressed under conditions of pressure of 12 kg/cm² and a temperature of 135° C. in an autoclave to prepare transparent laminated glass.

### Example 2

Laminated glass was prepared through the same process as that of Example 1, except for the use of a second resin composition prepared by collecting 61.35 g of the second polyvinylacetal resin (A), adding and mixing 36 g of triethyleneglycol-di-2-ethylbutyrate as a second plasticizer, 2 g of EXCEREX™ of MITSUI as a second ethylene-α-olefin copolymer, 0.5 g of trimethoxy(octyl)silane as a second silane-based compound, and 0.15 g of tetrakis[methylene-3-(3′,5′-butyl-4′-hydroxyphenyl)propionate]methane as an anti-oxidant, and subsequently sufficiently roll-mixing-milling the mixture with a mixing roller and adjustment of surface roughness of the second resin layer and the third resin layer to 22 μm.

### Comparative Example 1

Laminated glass was prepared through the same process as that of Example 1, except for the use of a first resin composition prepared by collecting 73.4 g of the first polyvinylacetal resin (B), adding and mixing 26 g of triethyleneglycol-di-2-ethylbutyrate as a first plasticizer and 0.6 g of 2-(2′-hydroxy-5′-methylphenyl)benzotriazole as a ultraviolet absorbent, and subsequently sufficiently roll-mixing-milling the mixture with a mixing roller.

### Experimental Example 1

### Measurement of Maximum Coefficient of Static Friction of Second Resin Layer and Third Resin Layer

A resin film was mounted on a level SUS plate, a planar weight of 65*65 mm(500g) was mounted thereon, and the SUS plate was sloped to measure an angle when the planar weight slid. The measured angle was converted into a coefficient of friction, and results thereof are illustrated in Table 1.

TABLE 1

| | maximum | maximum | maximum |
|---|---|---|---|
| | coefficient of | coefficient of | coefficient of |
| | static friction | static friction | static friction |
| Classification | 20° C. | 40° C. | 45° C. |
| Example 1 (second | 0.94 | 1.29 | 1.43 |
| resin layer/ | | | |
| third resin layer) | | | |
| Example 2 (second | 1.39 | 1.66 | 2.0 |
| resin layer/ | | | |
| third resin layer) | | | |
| Comparative Example 1 | 0.86 | 1.20 | 1.41 |
| (second resin layer/ | | | |
| third resin layer) | | | |

### Experimental Example 2

Physical properties of the laminated glass prepared in Examples 1, 2 and Comparative Example 1 were evaluated in the following manner and results thereof are illustrated in Table 2.

1) Sound insulation performance: Laminated glass was excited by a vibrator for testing damping (shaker of Shiken Co., Ltd, [G21-005D]) at a temperature of 20° C., vibration characteristics obtained therefrom were amplified with a mechanical impedance amplifier ([XG-81] of Lion Co., Ltd), and a vibration spectrum was interpreted by an FFT analyzer ([FFT spectrum analyzer HP 3582A] of YOKOGAWA Hewlett-Packard Company). Transmission loss was calculated from a ratio of an obtained loss coefficient and resonance frequency of the laminated glass. As a result, an infinitesimal amount of transmission loss in the vicinity of a frequency 2000 Hz was calculated as a TL value.

2) Optical performance (optical defect): The laminated glass was observed with naked eyes and optical performance was evaluated on the basis of whether a defect was observed.

TABLE 2

| | TL value (dB), | |
|---|---|---|
| Classification | 20° C. | Optical defect |
| Example 1 | 38 | Not observed |
| Example 2 | 39 | Not observed |
| Comparative | 37 | Observed |
| Example 1 | | |

Referring to Table 2, since the laminated glass was prepared using the resin composition including the ethylene-α-olefin copolymer, the TL value was so high that excellent sound insulation performance was obtained, and since an optical defect was not observed, excellent optical performance was confirmed.

In the present disclosure, since the resin film in which the first resin layer and/or the second resin layer is formed of the first resin composition including the first ethylene-α-olefin copolymer is applied to the laminated glass, it is possible to provide the laminated glass having excellent sound insulation performance and optical performance.

Also, since the resin film is prepared using the first resin composition including the first ethylene-α-olefin copolymer, it is possible to prevent pattern formation between the first resin layer and the second resin layer and between the first resin layer and the third resin layer, and thus, preparation efficiency of a resin film may be enhanced by 1.5 times or more, compared with the related art.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A resin film for laminated glass, the resin film comprising:
a first resin layer;
a second resin layer stacked on the first resin layer; and
a third resin layer stacked under the first resin layer,
wherein one or more of the second resin layer and the third resin layer is formed of a first resin composition,
the first resin composition comprises a first polyvinylacetal resin, a first plasticizer, and a first ethylene-α-olefin copolymer,
a content of the first ethylene-α-olefin copolymer is 0.1 to 10 parts by weight with respect to 100 parts by weight of the first resin composition, and
a weight-average molecular weight of the first ethylene-α-olefin copolymer is 1,000 to 30,000.

2. The resin film according to claim 1, wherein the first ethylene-α-olefin copolymer comprises a repeating unit (a) derived from ethylene of 30 to 90 mol % and a repeating unit (b) derived from α-olefin of 10 to 70 mol %.

3. The resin film according to claim 1, wherein α-olefin of the first ethylene-α-olefin copolymer is one or more selected from the group consisting of propylene, 1-butene, 1-pentene, 4-methy-l-pentene, 1-hexene, 1-heptene, 1-octene, 1-decene, 1-undecene, 1-dodecene, 1-tetradecene, 1-hexadecene, and 1-itocene.

4. The resin film according to claim 1, wherein the first resin composition further comprises a first silane-based compound.

5. The resin film according to claim 4, wherein the first silane-based compound comprises trimethoxy(octyl)silane or trimethoxy(octadecyl)silane.

6. The resin film according to claim 4, wherein a content of the first silane-based compound is 0.01 to 5 parts by weight with respect to 100 parts by weight of the first resin composition.

7. The resin film according to claim 1, wherein, in the first polyvinylacetal resin, the carbon number of an acetal group is 3 to 4, an acetyl group content is 4 mol % or less, and a degree of acetalization is 50 mol % or more.

8. The resin film according to claim 1, wherein the first resin composition further comprises a first additive, and the first additive is one or more selected from the group consisting of an ultraviolet absorbent, an ultraviolet stabilizer, an anti-oxidant, and a heat stabilizer.

9. The resin film according to claim 1, wherein the first resin layer is formed of a second resin composition, and the second resin composition comprises a second polyvinylacetal resin and a second plasticizer.

10. The resin film according to claim 9, wherein, in the second polyvinylacetal resin, the carbon number of an acetal group is 4 to 6, an acetyl group content is 8 to 30 mol %, and a degree of acetalization is 40 mol % or more.

11. The resin film according to claim 9, wherein, in the second polyvinylacetal resin, a standard deviation α of the ethylene group content to which an acetyl group is bonded is 2.5 to 8.

12. The resin film according to claim 9, wherein the second resin composition further comprises a second ethylene-α-olefin copolymer, and a weight-average molecular weight of the second ethylene-α-olefin copolymer is 1,000 to 30,000.

13. The resin film according to claim 12, wherein α-olefin of the second ethylene-α-olefin copolymer is one or more selected from the group consisting of propylene, 1-butene, 1-pentene, 4-methy-1-pentene, 1-hexene, 1-heptene, 1-octene, 1-decene, 1-undecene, 1-dodecene, 1-tetradecene, 1-hexadecene, and 1-itocene.

14. The resin film according to claim 9, wherein the second resin composition further comprises a second silane-based compound.

15. The resin film according to claim 14, wherein the second silane-based compound comprises trimethoxy(octyl)silane or trimethoxy(octadecyl)silane.

16. The resin film according to claim 9, wherein the second resin composition further comprises a second additive, and the second additive is one or more selected from the group consisting of an ultraviolet absorbent, an ultraviolet stabilizer, an anti-oxidant, and a heat stabilizer.

17. A laminated glass comprising:
a resin film according to claim 1;
a first glass panel stacked on the resin film; and
a second glass panel stacked under the resin film.

18. A resin film for laminated glass, the resin film comprising:
a first resin layer;
a second resin layer stacked on the first resin layer; and
a third resin layer stacked under the first resin layer,
wherein the second resin layer has a maximum coefficient of static friction ranging from 0.90 to 1.41 at about 20° C., a maximum coefficient of static friction ranging from 1.25 to 1.70 at about 40° C., and a maximum coefficient of static friction ranging from 1.40 to 2.10 at about 45° C.

19. The resin film according to claim 18, wherein the third resin layer has a maximum coefficient of static friction ranging from 0.90 to 1.41 at about 20° C., a maximum coefficient of static friction ranging from 1.25 to 1.70 at about 40° C., and a maximum coefficient of static friction ranging from 1.40 to 2.10 at about 45° C.
